(19) United States
(12) Patent Application Publication
(10) Pub. No.: US 2009/0104305 A1
(43) Pub. Date: Apr. 23, 2009

(54) Ejector Assembly for Ejecting Parts from a Mold

(75) Inventors: Joaquim Nogueira, Everett (CA); Robert Schad, North York (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/960,786

(22) Filed: Dec. 20, 2007

(30) Foreign Application Priority Data
Oct. 23, 2007 (CA) 2,607,397

(51) Int. Cl. B29C 45/40

(52) U.S. Cl. 425/556

(57) ABSTRACT

An ejection mechanism for an injection molding machine comprising a combination of hydraulic booster cylinders for initiating an ejection cycle of an ejection apparatus and an electromechanical drive for completing the ejection cycle and retracting the ejection apparatus after completion of the ejection the molded parts.

### TECHNICAL FIELD OF THE INVENTION

The present invention relates injection molding machinery. More specifically, the present invention relates to an ejector assembly for ejecting molded parts from a mold.

### BACKGROUND OF THE INVENTION

Some examples of known molding systems are: (i) the HyPET™ Molding System, (ii) the Quadloc™ Molding System, (iii) the Hylectric™ Molding System, and (iv) the HyMet™ Molding System, all manufactured by Husky Injection Molding Systems Ltd.

U.S. Pat. No. 5,122,051 (Inventor: Joyner; Published: 1992-06-16) discloses an injection molding machine with an article-ejection apparatus where linear and rotary ejection means can be used individually, or in sequence. More specifically, this patent discloses a part ejection apparatus for ejecting molded parts from a mold carried by a moveable platen in an injection molding machine. A plurality of linearly operating hydraulic cylinders move an ejector bar that is carried along guide rods supported by a moveable platen so that the ejector bar moves toward and away from a mold member that is carried by the moveable platen. Suitable connections can be provided between the ejector bar and the ejection mechanism of the mold to drive ejector pins carried by the mold for separating the molded part from the mold surface. Additionally, a rotary motor is also carried by the moveable platen and has its axis coincident with the longitudinal axis of the moveable platen for connection of an output shaft of the motor with a drive mechanism carried by a mold. The drive mechanism is suitable for rotating cores that form internal threads on the molded article. The linear and rotary ejection apparatus can be used individually, or they can be used in appropriate sequence in a core-type mold where separation of the cores does not simultaneously effect separation of the part from the mold.

Japanese Patent Application Number 4-168018 (Inventor: Watanabe et al; Published: 16 Jun., 1992) discloses an ejection mechanism in an ejector device for an injection molding machine. More specifically, this patent application discloses an ejector device with an attachment frame fixed to the rear surface of the moving platen in an injection molding machine. A servo motor and a speed reducer are connected to the fixed attachment frame on which a slide plate with an ejector pin projects from its front surface so as to permit movement to the front and rear. The output shaft of the speed reducer and the slide plate are connected by a crank mechanism in which the first link is longer than the second link. One end of the first link is attached firmly to the output shaft of the speed reducer. One end of the second link is attached to the rear surface of the slide plate so as to be freely rotatable. The other ends of the first link and the second link are rotatably joined together. A control means is provided which controls the rotation of the servo motor so that the first link moves reciprocally over a prescribed angular range, which is less than 45 degrees with respect to the line of the injection axis.

U.S. Pat. No. 5,736,079 (Inventor: Kamiguchi et al; Published: 1998-04-07) discloses controlling an ejector for an injection molding machine in which an ejector mechanism is driven by a servo motor. An ejector pin in the ejector mechanism is made to perform a motion such that the ejector pin reaches a predetermined protrusion limit position beyond a position where the removal of a molded product from a cavity or core is completed after making a check for positioning. A plurality of cycles of reciprocating motion of short amplitude is performed such that the ejector pin: (i) neither retracts beyond a position where the removal of the molded product from the cavity or core is started, (ii) nor protrudes to the protrusion limit position without requiring a check for positioning.

U.S. Pat. No. 5,824,350 (Inventor: Wietrzynski; Published: 1998-10-20) discloses a plastic molding tool with an accessory and an ejector or core pin unit that includes a date marking unit at a pin end that faces the plastic material during a molding operation. The date marking unit is used for marking the date of manufacture on components. More specifically, this patent discloses a mold for molding or injection-molding polymer compounds. At least one mold ancillary unit, in particular an ejector device, preferably an ejector pin, and/or a core pin device is distinguished by the fact that the mold ancillary device has, at least over a region, a marker unit in the region facing the polymer compound during the molding or injection-molding of the article.

PCT Patent Application Number WO 02/40246 (Inventor: Weinmann et al: Published: 23 May 2002) discloses ejection of injection molded components from a molding tool that utilizes a load stored in a spring at the end of an ejection cycle to assist with molding release in the following cycle. More specifically, this patent application discloses a method and an ejection device for the ejection of injection-molded pieces from injection molds. The ejection device includes an electric motor drive for the ejector pin. The electric motor drive, at least in the last section of the return travel thereof, tensions a spring for energy storage. The spring tension force is subsequently used to begin the ejection movement by supporting the breaking free of the injection molded pieces. By means of a particularly advantageous embodiment, the spring force is applied in combination with a cam drive to augment the cam drive maximum in the region of the dead point with the equivalent maximum of the tensile spring force. A slide plate on which ejector pins are mounted is displaced by means of an electric motor using a lever drive. Two particular features are: (i) a support frame open at the rear for the cam movement, and (ii) preferably four guide columns on which the slide plate runs. The slide plate movement is thus more stable and, above all, takes account of the usually unequal releasing force for the various ejector pins.

U.S. Pat. No. 6,811,391 (Inventor: Klaus et al; Published: 2004-11-02) discloses an electrically operated ejector mechanism for ejecting molded parts from a mold. The ejector mechanism uses an electric, reversible servo motor with an output shaft connected to a cam. More specifically, this patent discloses a molded part ejection system that includes a drive mechanism having a reversible servo motor. The drive mechanism for the ejection system includes a cam-and-follower arrangement whereby a circular cam member is driven by the servo motor through a drive shaft that is: (i) connected with the cam member and (ii) offset from the center of the circular cam track. A cam follower is connected with an ejector drive rod. The cam follower rides in the cam track to cause linear movement of the ejector drive rod as the cam follower follows the circular cam through its non-circular path of motion. Rotation of the servo motor in one direction of rotation operates the part ejection system, while rotation of the servo motor in the opposite direction of rotation provides power to another portion of the machine during another portion of a molding machine operating cycle, such as a core-pull system. The servo motor drive shaft includes a pair of one-way clutches that are each operable in a different direction of rotation of the motor drive shaft. In one direction of rotation, the motor actuates a part ejection mechanism. In the other direction of rotation, the motor can provide power to operate a different system of the molding machine. A single motor is permitted to perform two functions at different times during the operating cycle of an injection molding machine.

German Patent Number 10,060,128 (Inventor: Becker et al: Published: 2005-05-12) discloses an ejection mechanism for injection molded components. The mechanism has an ejector plate moved by a crank drive between active and non-active positions. The mechanism includes a spring compressed at the end of the return stroke. More specifically, this patent discloses a device for ejecting injection molded parts from an injection mold held by a platen in an injection molding machine. The device includes an ejection plate to which at least one ejector pin is fixed or can be fixed. The pin is positioned in a moveable tool half of the injection mold in an axially displaceable manner. The ejector-receiving element can be moved from a retraction position into an ejection position via linear guiding mechanisms, parallel to the longitudinal axis of the at least one ejector pin, by means of a motor-driven crank mechanism that includes a crankshaft, a crank and a connecting rod. A spring force storage device is provided in which the spring force thereof acts in the direction of the ejection position. The connecting rod is embodied as an arched component.

Japanese patent 07214610 (Inventor: Hiroshi, published 1995-08-15) teaches an ejector device of an injection molding machine. The purpose of the machine is to shorten a molding cycle by a method a large ejection force is produced in an initial ejection stage, and after the release of a molded piece from a mold, the molded piece is ejected at a high speed. A flange is provided on a movable platen through guide rods. An ejector bar is movably thrust through by the guide rods. A driving means for driving the ejector bar is provided. The drive means is composed of a large-diameter hydraulic cylinder having a short stroke and small-diameter hydraulic cylinders having a long stroke. A top surface of a piston rod of the large-diameter cylinder separately abuts on a head of an adjuster bolt. A top of a piston rod of the small-diameter cylinder is connected to the ejector bar. The large-diameter cylinder and the small-diameter cylinders are each connected to the pipes in parallel to be connected to an oil pressure source and a tank through a three-position solenoid operated valve.

PCT patent application WO/02057062A1 (Inventor: Zelleröhr, published 2002-07-25) teaches The invention relates to an ejector device for moulding machines such as injection moulding machines, diecasting machines or the like. The ejector device comprises an ejector tool (40) which is fixed to an ejector plate (30). The ejector plate (30) is displaced by a drive from a spindle nut (60) and a threaded spindle (54) in the direction of a mould mounting plate (10) for ejection of a moulded part from a mould. In order to provide as high a force as possible at the beginning of the ejection process, an additional mechanical drive with another spindle nut (50) and a corresponding threaded section (52) is provided. The thread pitch of the threaded section (52) is lower than that of the threaded section (54). The second spindle nut (50) can be rotated counter to the mould mounting plate but is secured against axial displacement. If the second threaded nut is rotated, it displaces the threaded spindle and thereby the ejector plate in the direction of the mould mounting plate with a relatively large amount of force.

In our earlier filed application U.S. Ser. No. 11/627,413 (Inventors: Schad et al.: filed 2007-01-26), there is provided an actuator of a molding system. The actuator includes: (i) an ejector plate, (ii) an ejector rod fixedly connected to the ejector plate, (iii) connecting links pivotally coupled to the ejector plate to transmit substantially balanced applied forces to the ejector plate, (iv) cranks pivotally connected to a respective link of the connecting links, (v) crank shafts fixedly connected to respective cranks, (vi) a drive shaft, (vii) an electric motor configured to rotate the drive shaft, and (viii) a belt coupling the drive shaft to the crank shafts, in response to the drive shaft being rotated by the electric motor. The belt moves so as to rotate the crank shafts. In response to the crank shafts being rotated by the belt, the cranks rotate so as to move the connecting links. In response to the connecting links being pushed by the cranks, the ejector plate receives the substantially balanced applied forces from the connecting links. In response to the ejector plate receiving the substantially balanced applied forces, the ejector rod move through a moveable platen of the molding system and a moveable mold portion supported by the moveable platen, the ejector rods pushes a molded article molded and retained in the moveable mold portion.

### SUMMARY OF THE INVENTION

According to a first aspect of the present invention, there is provided an ejector assembly for a molding machine, operable to move an ejector plate between a retracted position and an extended position to detach a molded article from a mold, the ejector assembly having an electromechanical assembly operable to move the ejector plate between the retracted position and the extracted position. At least one booster is operable to move the ejector plate from the retracted position at least a portion of the distance towards the extended position, the at least one booster providing additional force to detach the molded article from the mold.

According to a second aspect of the present invention, there is provided an ejector assembly, comprising a hollow electric motor; a ball screw drive; at least one hydraulic piston; and a part ejector assembly. The hollow electric motor is configured to drive the ball screw drive and the ball screw drive is configured to move the ejector assembly laterally. The at least one hydraulic piston is configured to initiate lateral movement of the ejector assembly toward an ejection position.

According to a third aspect of the invention, there is provided an ejector assembly for a molding machine, operable to move an ejector plate between a first position and a second position, having an electromechanical assembly, operable to urge the ejector plate towards one of the first position and the second position with a first quantity of force. A fluid power assembly is provided, operable to urge the ejector plate a portion of the distance towards the first position with a second quantity of force.

The invention further provides an ejector mechanism for a molding machine that is operable to move an ejector assembly between a first position and a second position that includes an electromechanical assembly operable to urge the ejector assembly towards one of the first position and the second position with a first quantity of force and a fluid power assembly operable to urge the ejector assembly at least a portion of the distance towards the first position with a second quantity of force. The present invention provides a fast, but compact, system for ejecting parts from a mold.

### BRIEF DESCRIPTION OF THE DRAWINGS

Exemplary embodiments of the present invention will now be described with reference to the accompanying drawings in which:

FIG. 1 is a perspective view of a molding system according to a first exemplary embodiment;

FIG. 2 is a perspective view of an ejector assembly mounted to the molding system of FIG. 1;

FIG. 3 is a side view of the ejector assembly shown in FIG. 2;

FIG. 4 is a side cross-sectional view of the ejector assembly shown in FIG. 3, with an ejector plate in the retracted position.

FIG. 5 is a side sectional view of the ejector assembly shown in FIG. 3 with the ejector plate in a slightly forward position;

FIG. 6 is a side sectional view of the ejector assembly shown in FIG. 3 with the ejector plate in the fully forward position; and

FIG. 7 is a side sectional view of a booster for the ejector assembly shown in FIG. 3.

### DETAILED DESCRIPTION OF THE PREFERRED EMBODIMENTS

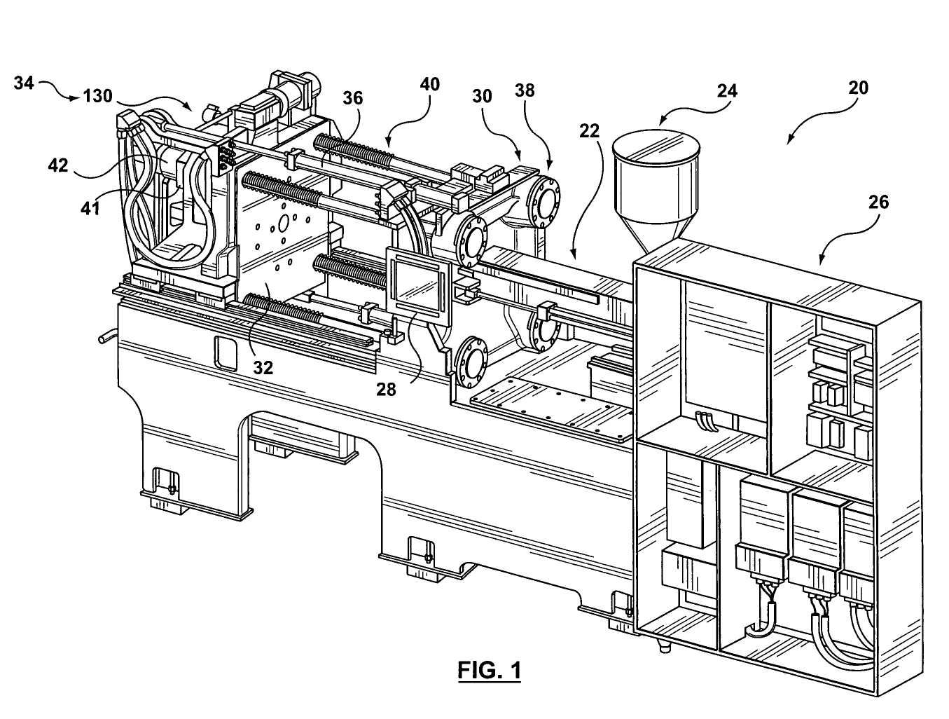

FIG. 1 is the perspective view of a molding system 20 (preferably an injection molding system hereafter referred to as the “system 20”) according to the first exemplary embodiment. The system 20 is used to mold one more molded articles (not shown). The system 20 includes components that are known to persons skilled in the art and these known components will not be described here; these known components are described, by way of example, in the following references: (i) Injection Molding Handbook by Osswald/Turng/Gramann ISBN: 3-446-21669-2; publisher: Hanser, and (ii) Injection Molding Handbook by Rosato and Rosato ISBN: 0-412-99381-3; publisher: Chapman & Hill.

The system 20 includes (amongst other things): (i) an injection-type extruder 22 (hereafter referred to as the “extruder 22”), (ii) a hopper 24, (iii) a control cabinet 26, (iv) a human-machine interface, hereafter referred to as the “HMI 28”, (v) a stationary platen 30, (vi) a moveable platen 32, and (vii) an ejector assembly 34 (described in greater detail below). FIG. 1 depicts an approximate location of the ejector assembly 34 relative to the system 20. The extruder 22 has a barrel and a reciprocating screw disposed in the barrel. Alternatively, the extruder 22 could be a two stage shooting pot configuration. The hopper 24 is coupled to a feed throat of the extruder 22 so as to deliver pellets of moldable material to the extruder 22. The extruder 22 is configured to: (i) process the pellets into an injectable molding material, and (ii) inject the injectable material into a mold that is held closed by the platens 30, 32 after the platens 30, 32 have been stroked together. The control cabinet 26 houses control equipment that is used to control the system 20. The HMI 28 is coupled to the control equipment, and the HMI 28 is used to assist an operator in monitoring and controlling operations of the system 20.

The stationary platen 30 is configured to support a stationary mold portion of a mold (not shown). The moveable platen 32 is configured to: (i) support a moveable mold portion of the mold, and (ii) move relative to the stationary platen 30 so that the mold portions of the mold (neither shown) may be separated from each other or closed together. A platen stroke actuator 36 (hereafter referred to as the “actuator 36”) is coupled to the platens 30, 32. Preferably, there are two platen stroke actuators, each of which are mounted, respectively, at opposite diagonal corners of the platens 30, 32. The actuator 36 is used to stroke the moveable platen 32 relative to the stationary platen 30. The stationary platen 30 supports four clamp actuators 38 that are each positioned in respective corners of the stationary platen 30. Four tie bars 40 each extend from their respective clamp actuators 38 toward respective corners of the moveable platen 32. The tie bars 40 are lockable relative to the moveable platen 32 by usage of respective tie-bar locks 41 that are each supported in respective corners of the moveable platen 32.

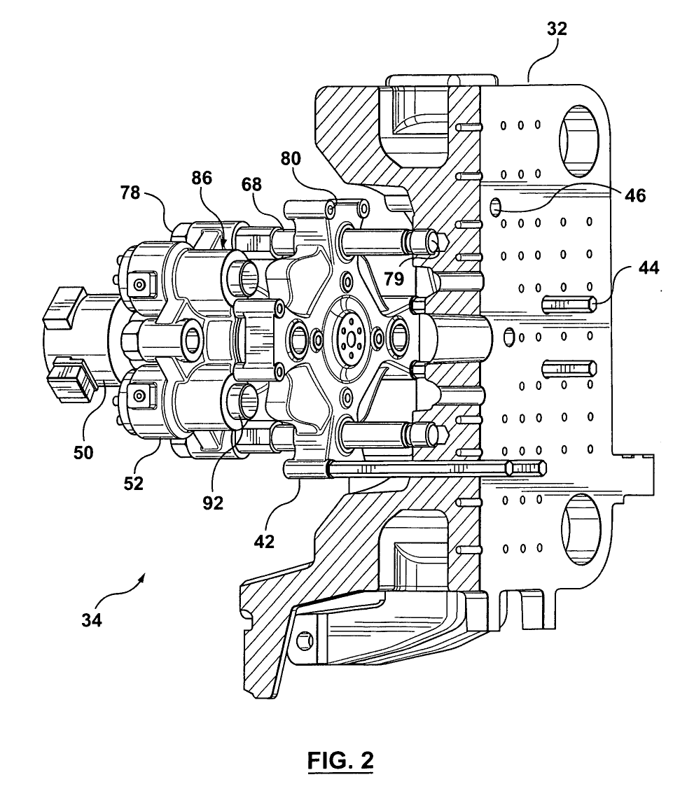

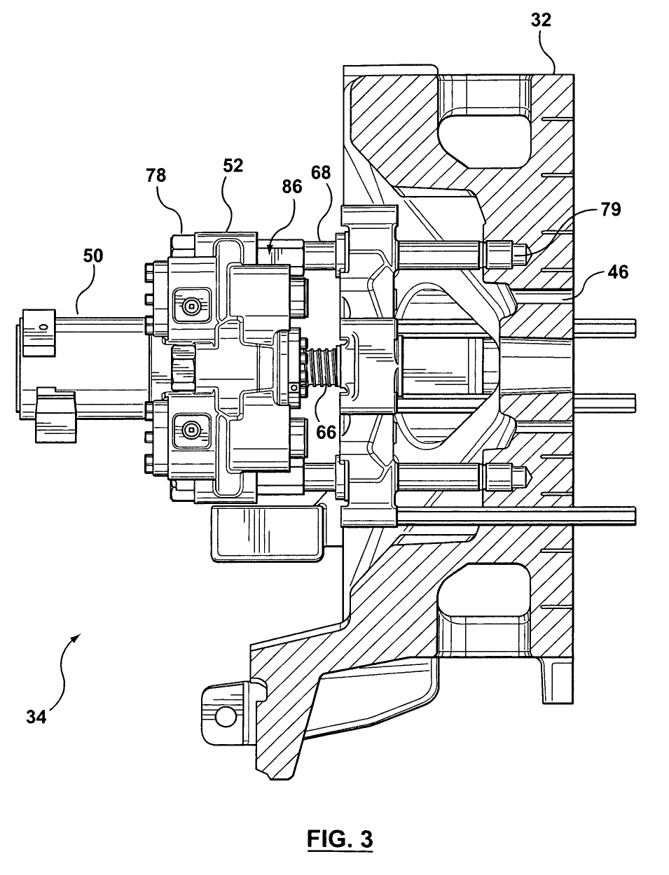

Referring now to FIGS. 2 and 3, ejector assembly 34 is shown in greater detail, and depicts the location of the ejector assembly 34 relative to the movable platen 32. The ejector assembly 34 is used to move, displace or linearly translate an ejector plate 42. The ejector plate 42 is fixedly connected to a set of ejector pins 44 (that is, one or more ejector pins 44), which extend through apertures 46 defined in the movable platen 32. For the purposes of clarity, some of the ejector pins 44 have been removed from FIGS. 2 and 3. The ejector pins 44 further extend through apertures in the adjacent mold half (none shown), and are operable to dislodge molded articles via the movement of ejector plate 42 in a manner known to those of skill in the art.

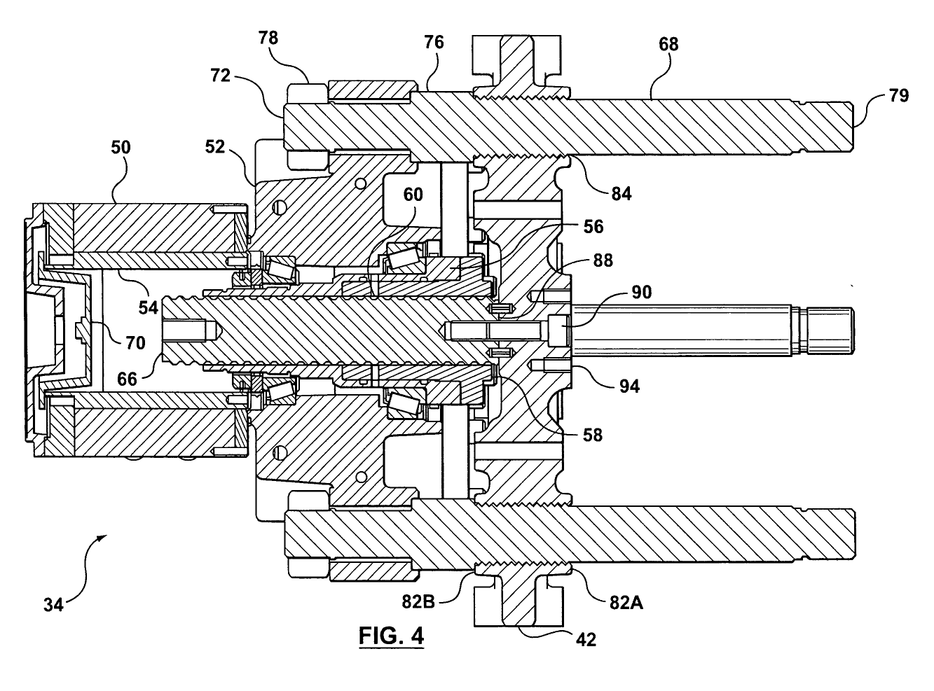

Referring additionally to FIG. 4, ejector assembly 34 further includes an electro-mechanical assembly operable to linearly translate ejector plate 42. The electro-mechanical assembly includes a motor 50 that is mounted to a housing 52. Preferably, motor 50 is reversible hollow electric motor, but other types of motors will occur to those of skill in the art. When motor 50 is engaged, motor 50, a rotor 54 drives an output shaft 56, the output shaft 56 being supported in housing 52 by bearings 64. In the presently-illustrated embodiment, the output shaft 56 is an annular shaft, coaxially mounted within the hollow cavity of rotor 54, but other transmission arrangements between output shaft 56 and motor 50 are within the scope of the art. For example, output shaft 56 could be belt or gear driven by motor 50 (although such a transmission would typically require more packaging than the currently-illustrated embodiment). Alternatively, depending on the sizing of the shaft and the motor, a gear reducer could be used (none shown).

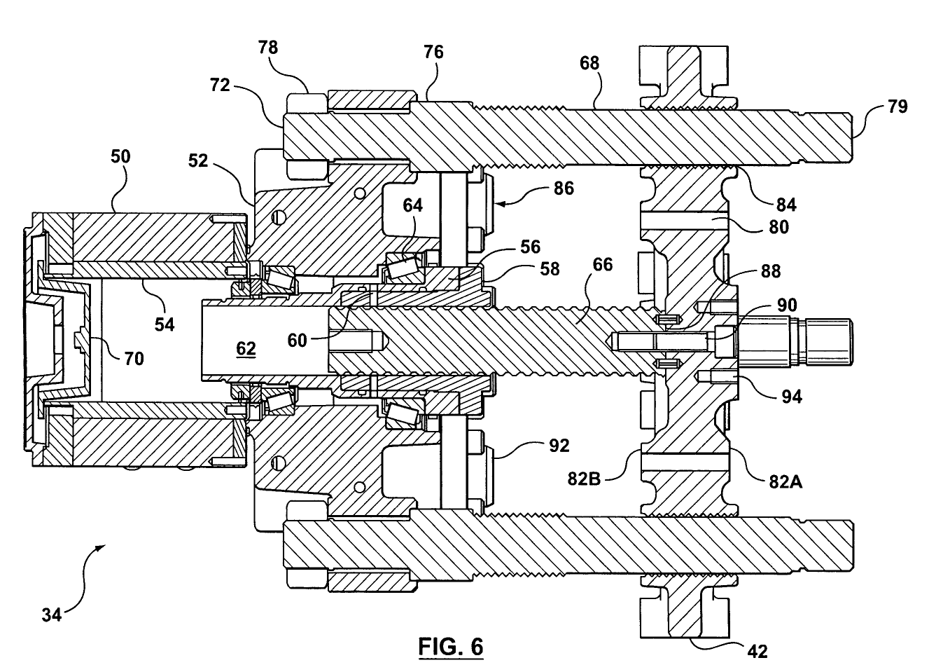

Motor 50 reversibly drives a ball screw. A ball nut 58 is fixedly mounted on the distal end of output shaft 56 (i.e., away from motor 50) by drive pins 60 so that engaging motor 50 rotates ball nut 58. Ball nut 58 and output shaft 56 define a common diameter bore 62 (best seen in FIG. 6). A screw shaft 66, having threads complementary to ball nut 58, extends through bore 62. Balls (omitted for the purposes of clarity) are packed between ball nut 58 and screw shaft 66. When motor 50 engages, ball nut 58 translates the screw shaft 66 via the balls. The range of travel of screw shaft 66 is delimited by a bottom 70 on motor 50 in the first, inward direction, and normally, by the movable platen 32 (FIGS. 1 and 2) in the second, outward direction. (If motor 50 is engaged while the ejector assembly 34 is dismounted from the movable platen 32, then engaging motor 50 in the second direction will cause screw shaft 66 to exit bore 62.

Housing 52 is spaced apart from and mounted to the movable platen 32 (FIGS. 1 and 2) by parallel guide rods 68. In the presently-illustrated embodiment, four guide rods 68 are radially distributed around housing 52 (for the purposes of clarity, only two guide rods 68 are shown). A first end 72 for each of guide rods 68 extend through a bore 74 provided within housing 52, and is retained in place by a flange portion 76 on one side of housing 52 and a nut 78 on the other side of housing 52. A second end 79 of each guide rod is fixedly mounted to the movable platen 32 (FIGS. 1 and 2).

The ejector plate 42 is movably located between housing 52 and movable platen 32, and during operation of ejector assembly 34, translates along guide rods 68. A first planar surface 82A on ejector plate 42 faces towards the movable platen 32 (FIGS. 1 and 2), and a second planar surface 82B faces towards housing 52. Each guide rod 68 extends through a guide bore 84 defined by ejector plate 42. Preferably, each guide bore 84 includes bearings to ensure smooth movement of ejector plate 42 along the guide rods 68. Pin mounts 80 are provided to locate and fasten ejector pins 44 to ejector plate 42.

A second end 88 of screw shaft 66 is fixedly mounted to the second surface 82B of ejector plate 42 via a bolt 90, thereby coupling the linear motion of screw shaft 66 to ejector plate 42. Locator pins 94 assist positioning ejector plate 42 on screw shaft 66. Motor 50 acts as the primary motivator to translate ejector 80 between a retracted position (proximate housing 52) and an extended position (proximate the movable platen 32) for parts ejection, and then return it back to the retracted position.

Radially spaced around the peripheral regions of housing 52 is a plurality of boosters, each operable to act as a secondary motivator in moving ejector plate 42 from the retracted position to the extended position. In the presently-illustrated embodiment, the boosters are hydraulic pistons 86. Generally speaking, hydraulic pistons 86 generate a significantly larger force acting on ejector plate 42 than motor 50, albeit only for a portion of the travel distance of the ejector plate from the retracted position (FIG. 4) to the extended position (FIG. 6). Also generally speaking, hydraulic pistons 86 do not assist ejector plate 42 in returning to the retracted position from the extended position.

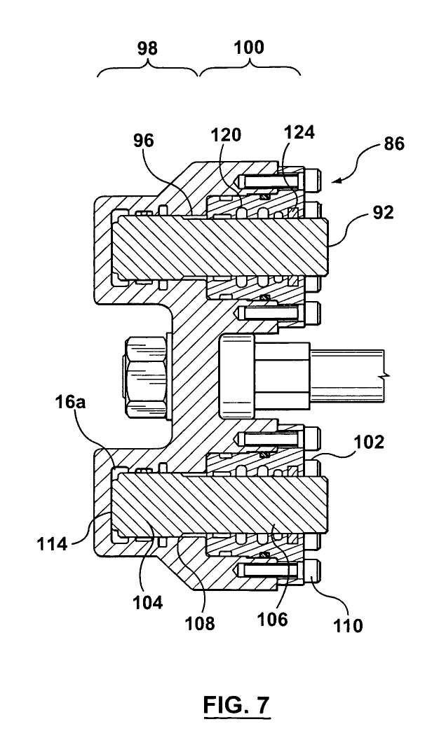

Referring additionally to FIG. 7, each hydraulic piston 86 has a piston rod 92, slidably located within a booster cylinder 96, the piston rod being operably extensible towards the ejector plate 42. The piston rods 92 are aligned parallel with the longitudinal axis of screw shaft 66. The hydraulic pistons 86 initiate movement of the ejector plate 42 by driving piston rods 92 into engagement with the second surface 82B of ejector plate 42 when the ejector plate is in the fully withdrawn position as will be more fully described hereinafter. In the presently-illustrated embodiment, four hydraulic pistons 86 are provided (for the purposes of clarity, only two are shown) but a different number could be used.

In the currently-illustrated embodiment, each booster cylinder 96 defines a first cylindrical chamber 98 and a second, narrower cylindrical chamber 100 that is in communication with first cylindrical chamber 98. The booster cylinders 96 can be mounted to housing 52, or integrally formed as part of housing 52. Second cylindrical chambers 100 are defined within end caps 102. The piston rods 92 have a larger diameter portion 104, sized for a fluid-tight fit within first cylindrical chamber 98, and a narrower diameter portion 106, sized for a fluid-tight fit within second cylindrical chamber 100. The larger diameter portion 104 of piston rod 92 subdivides first cylindrical chamber 98 into portions 116A and 116B. When assembling the boosters 86, the piston rods 92 are positioned within the first cylindrical chambers 98, and then, the second cylindrical chambers 100 slid over the narrow diameter portions 106 of the piston rods 92. The end caps 102 are secured to housing 52 via fasteners 110. A shoulder 108 on piston rod 92 prevents the larger diameter portion 104 from exiting first cylindrical chamber 98 into the second cylindrical chamber 100.

Piston rods 92 move between from a retracted position, where the base of piston rod 92 abuts a cylinder base 114 and an extended position, where shoulder 108 abuts the end cap 102 (i.e., towards ejector plate 42) by hydraulically pressurizing portion 116A of each first cylindrical chamber 98. For the purposes of clarity, the hydraulic ports and lines have been omitted from the illustration. Seals 120 are provided to prevent leakage of hydraulic fluid. Bearings 124 help piston rods 92 from moving between the retracted and extended positions. Hydraulic pistons 86 can be configured as single-action or dual action. Single-action hydraulic pistons 86 move piston rods 92 to the extended position by hydraulically pressurizing portion 116A of each first cylindrical chamber 98, but move the piston rods to the retracted position by the return movement of ejector plate 42. Dual action piston hydraulic pistons 86 move the piston rods 92 to the extended position by hydraulically pressurizing portion 116A of each first cylindrical chamber 98, and return the piston rods to the retracted position by hydraulically pressurizing the portion 116B of each first cylindrical chamber 98.

Referring now to FIGS. 4-6, an ejection sequence for ejector assembly 34 is shown. In FIG. 4, motor 50 is turned off and piston rods 92 are in their fully retracted position, i.e., fully withdrawn into hydraulic pistons 86. The ejector plate 42 is also in the retracted position, so that its second planar surface 82B abuts against the distal end faces 118 of piston rods 92.

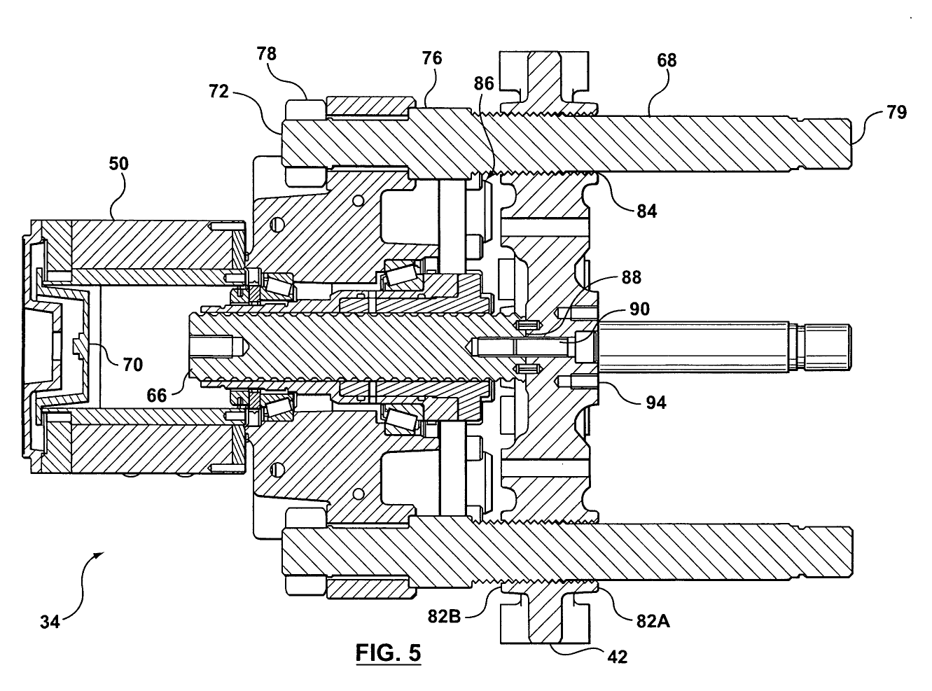

In FIG. 5, the hydraulic pistons 86 have been activated, and the movement of the ejector plate 42 towards the extended position has been initiated. Portion 116A of each first cylindrical chamber 98 is pressurized, moving the piston rods 92 to the extended position. When the booster cylinders are charged, the piston rods 92 are extended and push against the ejector plate 42. The pressure on the piston rods 92 is sufficient to overcome all the inertia created by the ejector assembly 34, including the ejector plate 42, ball nut 58 and the screw shaft 66. The motor 50 may also be engaged, but need not be during this initial phase as the initial driving force provided by the hydraulic pistons 86 is significantly greater that the force provided by the motor 50 through the output shaft 56 and ball nut 58. Piston rods 92 initiate accelerated lateral motion of the ejector plate 42 to a position beyond the end faces 118 of the piston rods 92. Movement of the ejector plate 42 creates lateral movement of the screw shaft 66 and accelerates rotation of ball nut 58 and rotor 54. If motor 50 was not engaged simultaneously with hydraulic boosters 56, then it is now energized so that rotor 54 rotates to rotate output shaft 56. The rotation of output shaft 56 rotates ball nut 58 to move screw shaft 66 laterally, driving ejector plate 42 towards its extended position.

In FIG. 6, the ejector plate 42 is in its fully extended position. The ejector pins 44 will have removed the molded articles from the mold cores (none shown). When the screw shaft 66 reaches the end of its stroke with the ejector plate 42 in its fully extended position the motor 50 is turned off.

After the ejection cycle is completed the motor 50 is energized in reverse to rotate the output shaft 56 and ball nut 58 in the reverse direction and thereby retract the screw shaft 66, ejector plate 42 and ejector pins 44 to the retracted position. If hydraulic pistons 86 are single-action hydraulic pistons 86, the piston rods 92 are retracted by the return movement of ejector plate 42 when no significant hydraulic charge exists in cylindrical chamber 116A. Alternatively, with double action hydraulic pistons 86, then cylindrical chamber 116B may be pressurized to retract the piston rods 92. Once the screw shaft 66 and piston rods 92 are returned to the fully retracted position shown in FIG. 4, the ejector assembly 34 is ready for its next ejection cycle.

When movement of the ejector plate 42 has been initiated by the action of the piston rods 92, the screw shaft 66 is also in motion. When the ejector plate 42 is in motion, the motor 50 does not need to overcome the inertia of a stopped system and can readily continue motion of the ejector assembly to eject molded parts. This combination of initiating motion by hydraulic means and maintaining motion by electromechanical means enables the assembly to be more compact. As the hydraulic pistons only move the plate a short distance the booster cylinders are short, compact and require a minimal amount of hydraulic fluid. As the motor 50 does not have to overcome the inertia of a stopped ejector assembly 34 a much smaller electric motor is needed.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An ejector assembly for a molding machine, operable to move an ejector plate between a retracted position and an extended position to detach a molded article from a mold, the ejector assembly having:
an electro-mechanical assembly, operable to move the ejector plate between the retracted position and the extended position;
at least one booster, operable to move the ejector plate from the retracted position at least a portion of a distance towards the extended position, the at least one booster providing additional force to detach the molded article from the mold.

2. The ejector assembly of claim 1, wherein the at least one booster is a hydraulic piston.

3. The ejector assembly of claim 1, wherein the ejector plate is detached from the at least one booster while the ejector plate travels another portion of the distance between the retracted position and the extended position.

4. The ejector assembly of claim 1, wherein the at least one booster generates a larger force acting on the ejector plate than the electromechanical assembly as the ejector plate begins to move from the retracted position to the extended position.

5. The ejector assembly of claim 1, wherein the at least one booster is configured to initiate movement of the ejector plate prior to the electro-mechanical assembly engaging.

6. The ejector assembly of claim 1, wherein the at least one booster is configured to initiate movement of the ejector plate generally simultaneously with the electro-mechanical assembly engaging.

7. The ejector assembly of claim 1, wherein the at least one booster and the electro-mechanical assembly are mounted in a common housing.

8. The ejector assembly of claim 1, wherein the at least one booster and the electro-mechanical assembly generate parallel forces acting on the ejector plate.

9. The ejector assembly of claim 8, wherein the at least one booster and the electromechanical assembly apply linear forces that are parallel with the direction of travel of the ejector plate.

10. The ejector assembly of claim 1, wherein the electro-mechanical assembly includes:
a motor;
a ball screw, driven by the motor; and
a screw shaft, linearly translated by the ball screw, and attached at one end to the ejector plate.

11. The ejector assembly of claim 10, wherein the motor includes a hollow rotor defining a rotor cavity, and the screw shaft is located at least partially into the rotor cavity when the ejector plate is in the retracted.

12. An ejector assembly, comprising
a hollow electric motor;
a ball screw drive;
at least one hydraulic piston; and
a part ejector assembly;
wherein the hollow electric motor is configured to drive the ball screw drive and the ball screw drive is configured to move the ejector assembly laterally; and
the at least one hydraulic piston is configured to initiate lateral movement of the ejector assembly toward an ejection position.

13. An ejector assembly as defined in claim 12 wherein the at least one hydraulic piston is configured to initiate movement of the ejector assembly prior to the hollow electric motor driving the ball screw drive.

14. An ejector assembly for a molding machine, operable to move an ejector plate between a retracted position and an extended position, having:
an electromechanical assembly, operable to urge the ejector plate towards one of the retracted position and the extended position with a first quantity of force,
a fluid power assembly operable to urge the ejector plate a portion of a distance towards the one of the retracted position and the extended position with a second quantity of force.
